(19) United States
(12) Patent Application Publication
(10) Pub. No.: US 2025/0166867 A1
(43) Pub. Date: May 22, 2025

(54) MULTI-CORE CABLE

(71) Applicant: SUMITOMO ELECTRIC INDUSTRIES, LTD., Osaka (JP)

(72) Inventors: Hirotaka KATO, Tochigi (JP); Takumi OOSHIMA, Tochigi (JP); Yutaka MATSUMURA, Osaka (JP)

(21) Appl. No.: 18/941,528

(22) Filed: Nov. 8, 2024

(30) Foreign Application Priority Data
Nov. 21, 2023 (JP) 2023-197347

(51) Int. Cl. H01B 7/18; H01B 3/30; H01B 3/50

(52) U.S. Cl. CPC H01B 7/1875; H01B 3/302; H01B 3/50; H01B 7/183; H01B 7/1855

(57) ABSTRACT

A multi-core cable includes a core formed of a plurality of electrical wires twisted together, a release layer configured to cover the core, and a jacket configured to cover the release layer. A tensile strength of the release layer is 10 MPa to 38 MPa. The release layer is fixed to the jacket.

### CROSS REFERENCE TO RELATED APPLICATIONS

This application claims priority based on Japanese Patent Application No. 2023-197347 filed on Nov. 21, 2023, and the entire contents of the Japanese Patent Application are incorporated herein by reference.

### TECHNICAL FIELD

The present disclosure relates to a multi-core cable.

### BACKGROUND

Patent literature 1 (Japanese Unexamined Patent Application Publication No. 2020-109756) discloses a multi-core cable including a core formed by twisting a plurality of insulated core wires and a sheath layer covering the outer periphery of the core.

### SUMMARY

A multi-core cable according to the present disclosure includes a core formed of a plurality of electrical wires twisted together, a release layer configured to cover the core, and a jacket configured to cover the release layer. A tensile strength of the release layer is 10 MPa to 38 MPa. The release layer is fixed to the jacket.

### BRIEF DESCRIPTION OF DRAWINGS

FIG. 1 is a cross-sectional view of a multi-core cable in a plane perpendicular to the longitudinal direction of the cable according to an embodiment of the present disclosure.

FIG. 2 is a diagram illustrating a fiber having a core-sheath structure.

FIG. 3 is a diagram illustrating an operation of removing a jacket at an end portion of the multi-core cable.

### DETAILED DESCRIPTION

In order to connect electrical wires included in a multi-core cable to a device or the like, a jacket collectively covering the electrical wires is conventionally removed at an end portion of the multi-core cable by pulling the jacket in the longitudinal direction of the multi-core cable. From the viewpoint of enhancing workability, it has been required that the jacket of the multi-core cable can be easily removed.

Thus, an object of the present disclosure is to provide a multi-core cable that allows for easy removal of the jacket.

Embodiments will be described below.

### DESCRIPTION OF EMBODIMENTS OF PRESENT DISCLOSURE

First, embodiments of the present disclosure will be listed and described. In the following description, the same or corresponding elements are denoted by the same reference numerals, and the same description thereof will be omitted.

(1) A multi-core cable according to an aspect of the present disclosure includes a core formed of a plurality of electrical wires twisted together, a release layer configured to cover the core, and a jacket configured to cover the release layer. A tensile strength of the release layer is 10 MPa to 38 MPa. The release layer is fixed to the jacket.

By setting the tensile strength of the release layer to 38 MPa or less, it is possible to easily cut the release layer and remove the jacket when the jacket to be removed is pulled in the longitudinal direction of the multi-core cable.

By setting the tensile strength of the release layer to 10 MPa or more, it is possible to reduce the breakage of a material such as a tape of the release layer during the manufacturing of the release layer, and to improve the productivity of the multi-core cable.

The release layer is fixed to the jacket, so that the release layer and the jacket are peeled off together from the core when the jacket is removed, thereby allowing easy removal of the jacket.

(2) In the above (1), a difference between a melting temperature of a material contained in a surface of the release layer in contact with the jacket and a melting temperature of a material contained in a surface of the jacket in contact with the release layer, may be 60° C. or lower.

By setting the difference between the melting temperature of the material contained in the surface of the release layer in contact with the jacket and the melting temperature of the material contained in the surface of the jacket in contact with the release layer to 60° C. or lower, a vicinity of the surface of the release layer in contact with the jacket is melted when the jacket is extrusion-molded on the release layer, and the release layer can be easily fixed to the jacket.

(3) In the above (1) or (2), the release layer may contain a plurality of materials. A difference between a melting temperature of each of at least some of materials contained in a surface of the release layer in contact with the jacket and a melting temperature of a material contained in a surface of the jacket in contact with the release layer, may be 60° C. or lower.

By setting the difference between the melting temperature of at least some of the material contained in the surface of the release layer in contact with the jacket and the melting temperature of the material contained in the surface of the jacket in contact with the release layer to 60° C. or lower, at least some of the surface of the release layer in contact with the jacket can be melted when the jacket is extrusion-molded on the release layer. Thus, when the jacket is extrusion-molded, at least some of the release layer can be fixed to the jacket.

(4) In any one of the above (1) to (3), the release layer may include a piece of nonwoven fabric.

The release layer includes a piece of nonwoven fabric, so that the release layer can be easily cut when the jacket is removed, thereby allowing easy removal of the jacket. Furthermore, since the release layer includes the piece of nonwoven fabric, it is possible to reduce the generation of fine scraps from a torn release layer when the jacket is removed.

(5) In the above (4), the piece of nonwoven fabric may include a fiber having a core-sheath structure including a core and a sheath disposed outside the core.

Since the fiber included in the piece of nonwoven fabric has a core-sheath structure, the fiber can be made to satisfy the properties required for the fiber and the piece of nonwoven fabric by selecting the materials of the core and the sheath. For example, by using different materials for the core and the sheath, the properties of the fiber and the piece of nonwoven fabric including the fiber can be easily controlled.

### DETAILS OF EMBODIMENTS OF PRESENT DISCLOSURE

One or more specific examples of a multi-core cable according to one embodiment of the present disclosure (hereinafter referred to as “the present embodiment”) will be described below with reference to the drawings. It is noted that, the present invention is not limited to these examples, but is defined by the scope of the claims, and is intended to include all modifications within the meaning and scope equivalent to the scope of the claims.

In this specification, the terms “first”, “second”, and the like may be added to the names of members, such as a first electrical wire, a second electrical wire, and so on. The terms “first”, “second”, and the like are used only to distinguish individual members and to prevent confusion in the description, and do not represent arrangement, priority, and the like. Thus, when there is no significant possibility of confusion or when collective reference is made, the term “electrical wire” may simply be used.

### [Multi-Core Cable]

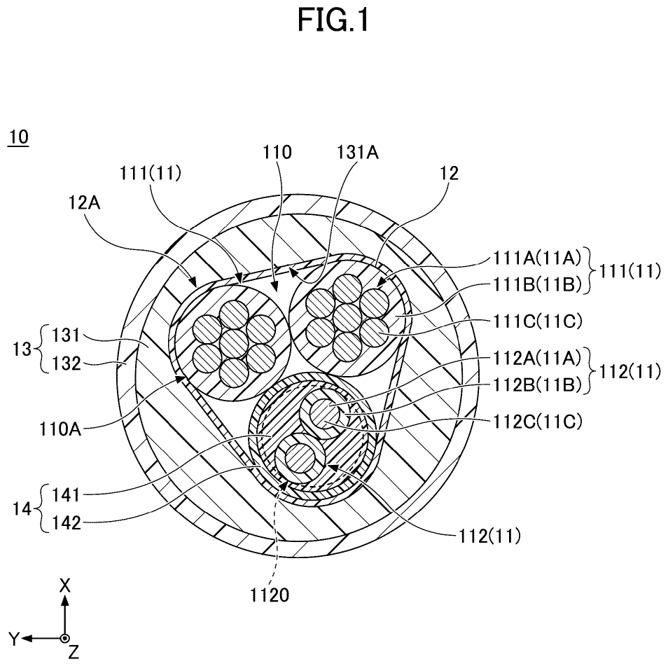

FIG. 1 is a schematic view of a cross section perpendicular to the longitudinal direction of the multi-core cable according to the present embodiment. In FIG. 1, the longitudinal direction of the multi-core cable is along a Z-axis, that is, an axis perpendicular to the plane of the paper. FIG. 1 illustrates a cross section in an X-Y plane perpendicular to the Z axis. FIG. 1 is a schematic diagram for illustrative purposes, and the number of electrical wires, the configuration, and the like of the multi-core cable of the present embodiment are not limited to those of the illustrated example.

As illustrated in FIG. 1, a multi-core cable 10 in the present embodiment includes a core 110 formed by twisting a plurality of electrical wires 11, a release layer 12 covering core 110, and a jacket 13 covering release layer 12.

Each member included in the multi-core cable of the present embodiment will be described.

### (1) Core

Core 110 has a configuration in which a plurality of electrical wires 11 are twisted together.

### (1-1) Electrical Wire

Electrical wire 11 included in core 110 may include a conductor 11A and an insulator 11B covering conductor 11A.

### (1-1-1) Conductor

Conductor 11A may be a stranded wire made by twisting a plurality of a conductor element wires 11C together.

For example, as illustrated in FIG. 1, a first conductor 111A may be a stranded wire formed of a plurality of first conductor element wires 111C twisted together. A second conductor 112A may be a stranded wire formed of a plurality of second conductor element wires 112C twisted together. In FIG. 1, first conductor element wire 111C is depicted as a single circle. It may be noted, however, that this single circle may either represent a stranded wire formed of a plurality of first conductor element wires 111C, or represent one first conductor element wire 111C. In FIG. 1, for second conductor element wires 112C, a single circle is used to represent a plurality of second conductor element wires 112C.

The material of conductor 11A is not particularly limited, and for example, copper alloy or copper can be used. The conductor may be unplated or plated.

### (1-1-2) Insulator

Insulator 11B can cover the outer surface of conductor 11A as illustrated in FIG. 1.

### (Resin Material)

Insulator 11B may include a resin material. The resin material is not particularly limited, and for example, one or more resins selected from fluororesins such as polytetrafluoroethylene (PTFE), tetrafluoroethylene-perfluoroalkyl vinyl ether copolymer (PFA), tetrafluoroethylene-hexafluoropropylene copolymer (FEP), and ethylene-tetrafluoroethylene copolymer (ETFE), polyolefin resins such as polyethylene and polypropylene, copolymers of olefin and a comonomer (ethylene-vinyl acetate copolymer (EVA), ethylene-ethyl acrylate copolymer (EEA), ethylene-methyl acrylate copolymer (EMA), etc.), and the like can be used. The resin for the insulator may be crosslinked or not crosslinked.

### (Additives)

Insulator 11B may contain one or more additives selected from a flame retardant, an antioxidant, a deterioration inhibitor, an acid acceptor, a colorant, a crosslinking agent, a crosslinking aid, a processing aid, a filler, a lubricant, and the like, in addition to the resin material.

### (1-2) Configuration of Electrical Wires Included in Core

The configuration of the plurality of electrical wires 11 included in core 110 of multi-core cable 10 in the present embodiment is not particularly limited. As the plurality of electrical wires 11 included in core 110, any number and combination of electrical wires 11 may be used depending on the application of multi-core cable 10.

For example, as illustrated in FIG. 1, core 110 of multi-core cable 10 can include two first electrical wires 111 and two second electrical wires 112 as the plurality of electrical wires 11.

First electrical wire 111 and second electrical wire 112 may have the configuration of electrical wire 11. That is, as illustrated in FIG. 1, first electrical wire 111 includes first conductor 111A which is conductor 11A and a first insulator 111B which is insulator 11B. Second electrical wire 112 includes second conductor 112A which is conductor 11A and a second insulator 112B which is insulator 11B. The details of these members are as described earlier.

Two second electrical wires 112 may be twisted together in advance to form a twisted electrical wire pair 1120. In a case of multi-core cable 10 in FIG. 1, twisted electrical wire pair 1120 and two first electrical wires 111 are twisted together to form core 110.

By forming second electrical wires 112 into the twisted electrical wire pair, second electrical wires 112 can reduce deterioration and attenuation of a signal to be transmitted. Furthermore, by forming second electrical wires 112 into the twisted electric wire pair, the two wires can be handled together during installation or the like, enhancing the workability of the wiring process.

Twisted electrical wire pair 1120 may further include a cover layer 14 covering the two twisted second electrical wires 112. Cover layer 14 may be configured with a single layer, or may be configured with two layers or three or more layers including a first cover layer 141 and a second cover layer 142.

The material of cover layer 14 is not particularly limited, and for example, the same material as insulator 11B may be used, or a different material may be used.

As a material of first cover layer 141, for example, one or more kinds selected from thermoplastic polyurethane elastomer, EVA, EEA, and the like can be used. As a material of second cover layer 142, for example, thermoplastic polyurethane elastomer or the like can be used.

Cover layer 14 may have a tape-wrapped configuration or may be an extrusion-molded resin tube.

Twisted electrical wire pair 1120 may be configured without cover layer 14 so that two second electrical wires 112 are exposed.

### (2) Release Layer

Release layer 12 may cover core 110 and may be disposed so as to be in direct contact with an outer surface 110A of core 110.

Release layer 12 may have a configuration in which a tape-shaped piece of nonwoven fabric or the like is wound around core 110, for example. The tape can be helically wound around core 110, for example. In doing so, an angle of the helically wound tape may be, for example, 25 degrees to 40 degrees with respect to an central axis (zero degrees) along the longitudinal direction of multi-core cable 10. An overlapping width of the tape may be, for example, ⅓ to ½ of the tape width.

Jacket 13 of multi-core cable 10 can be removed by, for example, the following first and second steps. In the first step, as illustrated in FIG. 3, at an end portion 10A of multi-core cable 10, a notch 31 is formed in jacket 13 so as to reach release layer 12. Next, in the second step, jacket 13 is pulled for removal in the longitudinal direction of multi-core cable 10 as shown by a block arrow 32.

In the first step, by selecting a length L13 corresponding to a distance from the terminal end of end portion 10A of multi-core cable 10 to a position where notch 31 is formed, it is possible to choose length L13 of jacket 13 to be removed, which is equal to a length of exposed core 110.

Conventionally, when length L13 of jacket 13 to be removed is, for example, 400 mm or more, notch 31 is formed in the first step so that length L13 of jacket 13 to be removed per process is about 100 mm, and the first step and second steps are repeated to remove a desired length of jacket 13. However, from the viewpoint of improving the productivity, there is a demand for multi-core cable 10 in which the jacket can be removed at once by performing the first step and the second step once even when length L13 of jacket 13 to be removed is 400 mm or more. Thus, in the present specification, the multi-core cable in which the jacket can be easily removed means a multi-core cable in which jacket 13 of which length L13 in the longitudinal direction of multi-core cable 10 is 400 mm or more can be removed at once.

Thus, the inventors of the present invention have studied multi-core cable 10 in which jacket 13 could be easily removed in the longitudinal direction even when length L13 of jacket 13 to be removed is 400 mm or more. During the course of this study, the inventors of the present invention particularly focused on a configuration in which release layer 12 is disposed between core 110 and jacket 13.

However, when release layer 12 is disposed between core 110 and jacket 13, and a portion of jacket 13 having a length L13 of 400 mm or more is removed at once at the end portion 10A along the longitudinal direction of multi-core cable 10, release layer 12 may become folded and clogged between jacket 13 and core 110. When release layer 12 is clogged between jacket 13 and core 110, a larger force is required to pull jacket 13, and thus, it may be difficult to remove jacket 13.

The inventors of the present invention have studied the cause of the clogging of release layer 12 between jacket 13 and core 110 when jacket 13 is removed. Eventually, it was found that when release layer 12 was clogged between jacket 13 and core 110, release layer 12 was not fixed to (adhered to) jacket 13.

In consideration of the above, multi-core cable 10 of the present embodiment may be configured such that release layer 12 is fixed to jacket 13. Since release layer 12 is fixed to jacket 13, release layer 12 and jacket 13 can be peeled off together from core 110 when jacket 13 is removed, which allows for the easy removal of jacket 13. The state of release layer 12 being fixed to jacket 13 can be confirmed in any one cross section perpendicular to the longitudinal direction of multi-core cable 10, and the presence of the fixation state can be identified by the fact that release layer 12 and jacket 13 are adhered to each other at least partially at the interface therebetween.

A melting temperature T12 of the material contained in a surface 12A of release layer 12 in contact with jacket 13 and a melting temperature T13 of the material contained in a surface 131A of jacket 13 in contact with release layer 12 may be selected for the purpose of fixing release layer 12 to jacket 13.

Melting temperature T12 and melting temperature T13 may be substantially the same, or T12 may be lower than T13. Melting temperature T12 may be higher than melting temperature T13. When a difference between melting temperature T12 and melting temperature T13 is about 60° C. or lower, the configuration in which release layer 12 is fixed to jacket 13 can be achieved.

Since surface 12A of release layer 12 in contact with jacket 13 and surface 131A of jacket 13 in contact with release layer 12 have some thicknesses, the surfaces 12A and 131A can be rephrased as a layer of release layer 12 in contact with jacket 13 and a layer of jacket 13 in contact with release layer 12, respectively.

In multi-core cable 10 illustrated in FIG. 1, for example, a melting temperature of release layer 12 is set as melting temperature T12, and a melting temperature of a first jacket 131 is set as melting temperature T13, and the melting temperatures can be compared.

The melting temperature means a peak temperature of an endothermic peak which appears first when a material to be evaluated is heated from room temperature (25° C.) at a temperature rise rate of 10° C./min by differential scanning calorimetry (DSC).

A difference between melting temperature T12 of a material contained in surface 12A of release layer 12 in contact with jacket 13 and melting temperature T13 of a material contained in surface 131A of jacket 13 in contact with release layer 12 may be 60° C. or lower.

By setting the difference between melting temperature T12 and melting temperature T13 to 60° C. or lower, when jacket 13 is extrusion-molded on release layer 12, at least a part of surface 12A of release layer 12 in contact with jacket 13 is melted, and release layer 12 can be easily fixed to jacket 13.

The difference between melting temperature T12 and melting temperature T13 may be 50° C. or lower.

Thus, the difference between melting temperature T12 and melting temperature T13 may be 0° C. to 60° C., or may be 0° C. to 50° C.

When release layer 12 includes a plurality of materials, a difference between a melting temperature T121 of at least some of the materials contained in the surface of release layer 12 in contact with jacket 13 and melting temperature T13 of the materials contained in the surface of jacket 13 in contact with release layer 12 may be 60° C. or lower.

By setting the difference between melting temperature T121 and melting temperature T13 to 60° C. or lower, at least part of surface 12A of release layer 12 in contact with jacket 13 can be melted when jacket 13 is extrusion-molded on release layer 12. Thus, when jacket 13 is extrusion-molded on release layer 12, at least part of release layer 12 can be fixed to jacket 13.

The difference between melting temperature T121 and melting temperature T13 may be 50° C. or lower.

Thus, the difference between melting temperature T121 and melting temperature T13 may be 0° C. to 60° C., or may be 0° C. to 50° C.

Release layer 12 may have a tensile strength of 38 MPa or less. By setting the tensile strength of release layer 12 to 38 MPa or less, it is possible to easily cut release layer 12 and remove jacket 13 when jacket 13 is pulled in the longitudinal direction of multi-core cable 10.

Release layer 12 may have a tensile strength of 15 MPa or less. By setting the tensile strength of release layer 12 to 15 MPa or less, release layer 12 can be cut more easily, and jacket 13 can be removed easily.

Release layer 12 may have a tensile strength of 10 MPa or more. By setting the tensile strength of release layer 12 to 10 MPa or more, it is possible to reduce the breakage of a material such as a tape of release layer 12 during the manufacturing of release layer 12, and to improve the productivity of the multi-core cable.

Thus, the tensile strength of release layer 12 may be set to, for example, 10 MPa to 38 MPa.

The material of release layer 12 is not particularly limited, and may include, for example, one or more resins selected from polyester resins such as polyethylene terephthalate (PET), polyolefin resins such as polyethylene and polypropylene, and the like.

Release layer 12 may be a piece of nonwoven fabric including resin fibers, or may be a tape having a resin base or the like.

As described above, release layer 12 can include, for example, a piece of nonwoven fabric. By including the piece of nonwoven fabric, release layer 12 can be easily cut when jacket 13 is removed, and jacket 13 can be easily removed. Furthermore, since release layer 12 includes the piece of nonwoven fabric, it is possible to reduce the generation of fine scraps from torn release layer 12 when jacket 13 is removed.

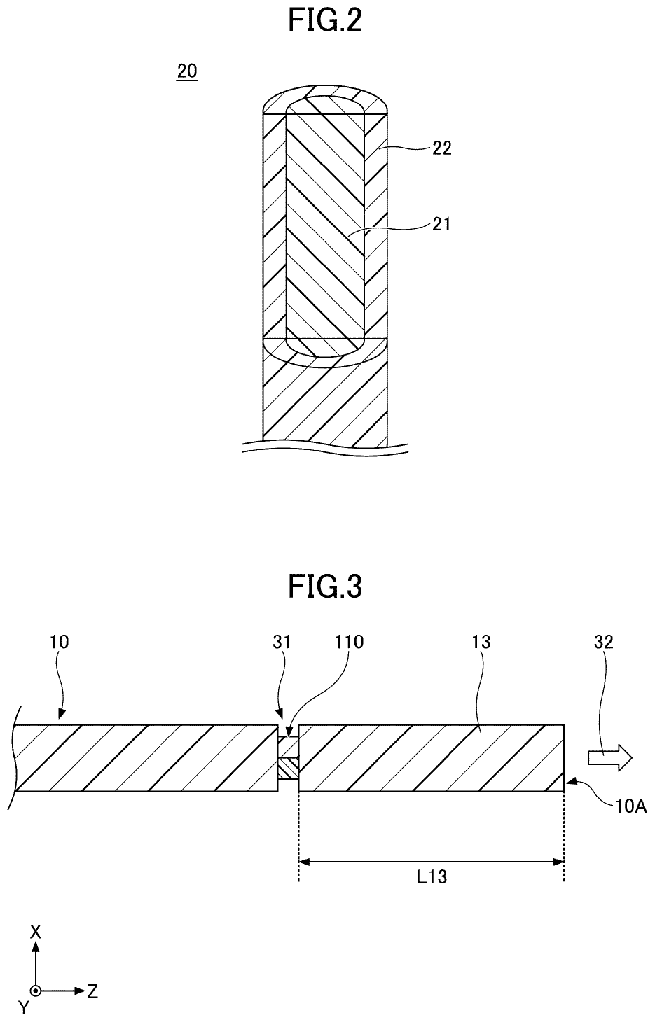

When release layer 12 includes a piece of nonwoven fabric, the piece of nonwoven fabric can include a fiber 20 having a core-sheath structure with a core 21 and a sheath 22 disposed outside core 21, as illustrated in FIG. 2. Core 21 and sheath 22 may be made of the same material or different materials. FIG. 2 is a perspective view illustrating fiber 20 having a core-sheath structure, in which a cross section of fiber 20 partially taken along a plane passing through the central axis is revealed.

Since the fiber included in the piece of nonwoven fabric has a core-sheath structure, the fiber can be made to satisfy the properties required for the fiber and the piece of nonwoven fabric by selecting the materials of core 21 and sheath 22. For example, by using different materials for core 21 and sheath 22, the properties of fiber 20 and the piece of nonwoven fabric including fiber 20 can be easily controlled.

For example, fiber 20 having a low melting temperature can be obtained by using a material having a relatively high melting temperature such as polyethylene terephthalate for core 21 and using a material having a relatively low melting temperature such as polyethylene for sheath 22. Thus, the piece of nonwoven fabric including fiber 20 can also have a low melting temperature.

### (3) Jacket

Jacket 13 can cover release layer 12 and can be disposed in direct contact with release layer 12.

Since multi-core cable 10 has jacket 13, electrical wires 11 included in core 110 are protected and the durability is enhanced.

### (Resin Material)

Jacket 13 may include a resin material. The resin material is not particularly limited, and for example, a polyolefin-based resin such as polyethylene or ethylene-vinyl acetate copolymer (EVA), a polyurethane elastomer (polyurethane resin) such as thermoplastic polyurethane elastomer (TPU), a polyester elastomer, or a composition formed by mixing at least two of these materials may be used.

As illustrated in FIG. 1, jacket 13 may include a plurality of layers such as first jacket 131 and a second jacket 132 in order from a position closer to core 110. Jacket 13 is not limited to the two-layer structure illustrated in FIG. 1, but may be a single-layer structure or a structure including three or more layers. First jacket 131 and second jacket 132 may be formed of different materials or the same material.

The materials of first jacket 131 and second jacket 132 are not particularly limited, and may contain the resin material described as the material of jacket 13.

First jacket 131 may contain, for example, one or more selected from a polyurethane resin and a polyolefin-based resin as a resin material.

Second jacket 132 may contain, for example, a polyurethane resin having excellent wear resistance as a resin material. Since second jacket 132 is disposed so as to include the outer surface of multi-core cable 10, second jacket 132 can improve the durability of multi-core cable 10 by containing a polyurethane resin as a resin material.

### (Additives)

Jacket 13 may contain one or more additives selected from a flame retardant, an antioxidant, a deterioration inhibitor, an acid acceptor, a colorant, a crosslinking agent, a crosslinking aid, a processing aid, a filler, a lubricant, and the like, in addition to the resin material.

### EXAMPLE

The present invention will be described below with reference to specific examples, but the present invention is not limited to these examples.

### (Evaluation Method)

First, a method of evaluating electrical wires produced in the following experimental examples will be described.

### (1) Processability Test

As illustrated in FIG. 3, notch 31 reaching release layer 12 was formed in end portion 10A of multi-core cable 10 at a distance of 408 mm from the terminal end of end portion 10A (first step). Next, jacket 13 was pulled in the longitudinal direction of multi-core cable 10 as indicated by block arrow 32 and removed (second step).

In the second step, when the jacket of the end portion was able to be removed, an “A” rating was given as a result of the evaluation. In the second step, when the jacket of the end portion was unable to be removed, a “B” rating was given as a result of the evaluation.

### (2) Melting Temperature

Melting temperatures of release layer 12 and first jacket 131 were evaluated by heating from room temperature (25° C.) at a temperature rise rate of 10° C./min using a DSC. In a DSC curve obtained above, a peak temperature of the first endothermic peak that appeared during heating was identified as the melting temperature.

### (3) Tensile Strength

A piece of nonwoven fabric used for release layer 12 was measured for tensile strength using a tensile tester in accordance with JIS L 1913 (2010).

### (Manufacturing Conditions of Multi-Core Cable)

The multi-core cable in each of the experimental examples will be described below.

The experimental examples 1 and 2 are working examples, and the experimental example 3 is a comparative example.

### Experimental Example 1 and Experimental Example 2

Multi-core cables having the same structure as multi-core cable 10 illustrated in FIG. 1 in the cross sections perpendicular to the longitudinal directions were produced.

The materials used for the release layer, the first jacket, and the second jacket are listed in the configuration column of Table 1.

Release layer 12 was formed by helically winding a nonwoven fabric tape including a fiber having a core-sheath structure in which the core was made of polyethylene terephthalate and the sheath covering the core was made of polyethylene around core 110. In the experimental example 2, there is no distinction between the first jacket and the second jacket, and there is one layer of jacket made of thermoplastic polyurethane elastomer.

In the configuration column of Table 1, the evaluation results of the tensile strength and the melting temperature (T12, T121) of release layer 12, and the melting temperature (T13) of first jacket 131 are also summarized. Melting temperature T12 or T121 of release layer 12 is a melting temperature of polyethylene used for the sheath.

The cross sections of the obtained multi-core cables were observed, and it was confirmed that release layer 12 was fixed to jacket 13.

The evaluation results are summarized in Table 1.

### Experimental Example 3

A multi-core cable was produced and evaluated under the same conditions as in Experimental Example 1 except that the materials of release layer 12 and first jacket 131 were changed. The evaluation results are summarized in Table 1.

TABLE 1

| | | | EXPERIMENTAL | EXPERIMENTAL | EXPERIMENTAL |
|---|---|---|---|---|---|
| | | | EXAMPLE 1 | EXAMPLE 2 | EXAMPLE 3 |
| CONFIGURATION | RELEASE | MATERIAL | PET/PE | PET/PE | PET |
| | LAYER | | NONWOVEN | NONWOVEN | NONWOVEN |
| | | | FABRIC | FABRIC | FABRIC |
| | | TENSILE | 10 | 38 | 65 |
| | | STRENGTH (MPa) | | | |
| | | MELTING | 130 | 130 | 260 |
| | | TEMPERATURE | | | |
| | | (T12, T121) (° C.) | | | |
| | FIRST | MATERIAL | EVA | TPU | EVA |
| | JACKET | MELTING | 80 | 130 | 80 |
| | | TEMPERATURE | | | |
| | | (T13) (° C.) | | | |
| | SECOND | MATERIAL | TPU | | |
| | JACKET | | | | |

| DIFFERENCE (° C.) BETWEEN MELTING TEMPERATURE | | 50 | 0 | 180 |
|---|---|---|---|---|
| T12(T121) AND MELTING TEMPERATURE T13 | | | | |
| EVALUATION | PROCESSABILITY TEST | A | A | B |

What is claimed is:

1. A multi-core cable comprising:
a core formed of a plurality of electrical wires twisted together;
a release layer configured to cover the core; and
a jacket configured to cover the release layer,
wherein a tensile strength of the release layer is 10 MPa to 38 MPa, and
wherein the release layer is fixed to the jacket.

2. The multi-core cable according to claim 1,
wherein a difference between a melting temperature of a material contained in a surface of the release layer, the surface being in contact with the jacket, and a melting temperature of a material contained in a surface of the jacket, the surface of the jacket being in contact with the release layer, is 60° C. or lower.

3. The multi-core cable according to claim 1,
wherein the release layer contains a plurality of materials, and
wherein a difference between a melting temperature of each of at least some of the materials contained in a surface of the release layer, the surface being in contact with the jacket, and a melting temperature of a material contained in a surface of the jacket, the surface of the jacket being in contact with the release layer, is 60° C. or lower.

4. The multi-core cable according to claim 1,
wherein the release layer includes a piece of nonwoven fabric.

5. The multi-core cable according to claim 4,
wherein the piece of nonwoven fabric includes a fiber having a core-sheath structure that includes a fiber core and a sheath disposed outside the fiber core.
